(19) United States
(12) Patent Application Publication
(10) Pub. No.: US 2018/0268743 A1
(43) Pub. Date: Sep. 20, 2018

(54) Image Forming Apparatus, Image Forming Method, and Recording Medium

(71) Applicant: Kyocera Document Solutions Inc., Osaka (JP)

(72) Inventor: Tetsuya Matsusaka, Osaka (JP)

(21) Appl. No.: 15/921,678

(22) Filed: Mar. 15, 2018

(30) Foreign Application Priority Data
Mar. 16, 2017 (JP) 2017-051997

(51) Int. Cl. G09C 5/00; G06F 3/12; H04N 1/00; H04N 1/32

(52) U.S. Cl. CPC G09C 5/00; G06F 3/1222; H04N 1/3232; H04N 1/00456; H04N 1/00411

(57) ABSTRACT

An image forming apparatus includes an encryption processing unit, a storage unit, a decryption processing unit, a decryption processing unit, and an image output unit. The encryption processing unit encrypts non-compressed image data that is not compressed and indicates a raw image as a target of the forming to generate encrypted image data. The storage unit stores the generated encrypted image data. The decryption processing unit decrypts the stored encrypted image data to restore the non-compressed image data. The image output unit forms the print image on the print medium using the non-compressed image data to output a printed matter. The image forming apparatus regards and processes the encrypted image data as the non-compressed image data to generate encryption confirmation image data indicating an encryption confirmation image, so as to associate and then display the encryption confirmation image with the printed matter using the encryption confirmation image data.

### INCORPORATION BY REFERENCE

This application is based upon, and claims the benefit of priority from, corresponding Japanese Patent Application No. 2017-051997 filed in the Japan Patent Office on Mar. 16, 2017, the entire contents of which are incorporated herein by reference.

### BACKGROUND

Unless otherwise indicated herein, the description in this section is not prior art to the claims in this application and is not admitted to be prior art by inclusion in this section.

A typical image forming apparatus, such as a multifunctional printer and a multi-functional peripheral (MFP), includes a model including a non-volatile large-capacity storage device, such as a hard disk drive and an SSD. When, for example, a copy and a fax transmission are performed, the large-capacity storage device stores image data once and then discards the image data after, for example, the copy is completed. However, even the image data is discarded, which simply causes the storage region storing the image data to become writable. This means that it does not necessarily prevent unauthorized use by a third person. Furthermore, there is a technique that restores the storage region even when the storage region of the image data is overwritten.

On the other hand, there has been proposed various kinds of techniques regarding also a process of image forming apparatus in terms of preventing unauthorized use of data. There is proposed a technique that determines whether an encryption process has been executed on image data accumulated in a portable recording medium or not. Then the technique performs a preview display of a non-encrypted image and displays an encrypted image with another mark to notify a user of the encryption. There is also proposed a technique that generates a two-dimensional bar code from an image of a print target and a time stamp to add the two-dimensional bar code to a printed matter, so as to prevent falsification of data. This technique is a technique that is focused on a point that a two-dimensional bar code of an identical time is unique. Furthermore, there is also proposed a technique where a first device converts print data into image data that can be restored to the print data, after the image data is printed and then a printed matter is obtained, a second device scans the printed matter to read the printed image data, restores the original print data from the read image data and prints the restored print data. This technique ensures performing sophisticated printing without a risk of data leakage.

### SUMMARY

An image forming apparatus according to one aspect of the disclosure forms a print image on a print medium. The image forming apparatus includes an encryption processing unit, a storage unit, a decryption processing unit, a decryption processing unit, and an image output unit. The encryption processing unit encrypts non-compressed image data. The non-compressed image data is not compressed and indicates a raw image as a target of the forming to generate encrypted image data. The storage unit stores the generated encrypted image data. The decryption processing unit decrypts the stored encrypted image data to restore the non-compressed image data. The image output unit forms the print image on the print medium using the non-compressed image data to output a printed matter. The image forming apparatus regards and processes the encrypted image data as the non-compressed image data to generate encryption confirmation image data indicating an encryption confirmation image, so as to associate and then display the encryption confirmation image with the printed matter using the encryption confirmation image data.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram illustrating a functional configuration of an image forming apparatus according to one embodiment of the disclosure.

FIG. 2 illustrates contents of a copy process according to the one embodiment.

FIGS. 3A and 3B illustrate explanatory diagrams illustrating examples of displaying an encryption confirmation image on a user interface screen according to the one embodiment.

FIGS. 4A and 4B illustrate explanatory diagrams illustrating examples of a copy layout using the encryption confirmation image according to the one embodiment.

FIG. 5 illustrates an explanatory diagram illustrating one example of a copy layout using an encryption confirmation image according to a first modification.

FIG. 6 illustrates an explanatory diagram illustrating one example of a copy layout using an encryption confirmation symbol according to a second modification.

FIG. 7 illustrates an explanatory diagram illustrating one example of a copy layout using an encryption confirmation symbol according to a third modification.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes a configuration for implementing the disclosure (hereinafter referred to as “embodiment”) with reference to the drawings.

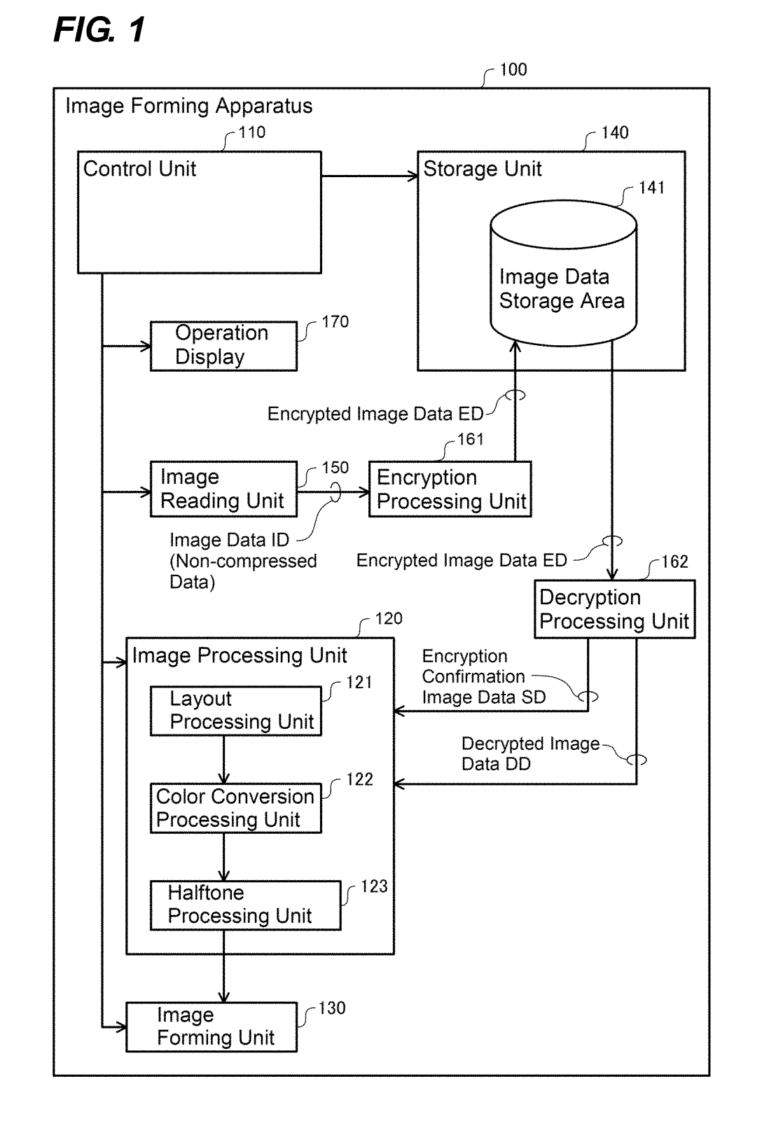

FIG. 1 illustrates a block diagram illustrating a functional configuration of an image forming apparatus 100 according to one embodiment of the disclosure. The image forming apparatus 100 includes a control unit 110, an image processing unit 120, an image forming unit 130, a storage unit 140, an image reading unit 150, an encryption processing unit 161, a decryption processing unit 162, and an operation display 170.

The image reading unit 150 reads an image from an original document to generate image data ID as digital data. The image data ID is data that is not compressed and has tone values of RGB for each pixel.

The image processing unit 120 includes a layout processing unit 121, a color conversion processing unit 122, and a halftone processing unit 123. The layout processing unit 121 sets a layout of print image in accordance with settings of, for example, scale, 1-sided/2-sided, and page aggregation (for example, 2 in 1). The color conversion processing unit 122 performs a color conversion on image data as RGB data on which a layout process has been executed into CMYK data. The halftone processing unit 123 executes a halftone process on the CMYK data to generate print data as halftone data of CMYK.

The image forming unit 130 forms a print image based on the print data on a print medium. The operation display 170 functions as a touch panel, displays various menus as an input screen, and accepts an operation input from a user. The image forming unit 130 is also referred to as an image output unit.

The control unit 110 includes a main storage unit, such as a RAM and a ROM, and a control unit, such as a micro-processing unit (MPU) and a central processing unit (CPU). The control unit 110 has a controller function related to an interface, such as various I/Os, a universal serial bus (USB), a bus, and other hardware, and controls the whole image forming apparatus 100.

The storage unit 140 is a storage device constituted of a hard disk drive, a flash memory, or similar medium, which is a non-transitory recording medium, and stores control programs and data for processes performed by the image forming apparatus 100. In the embodiment, the storage unit 140 further has an image data storage area 141 that temporarily stores image data when copying is performed.

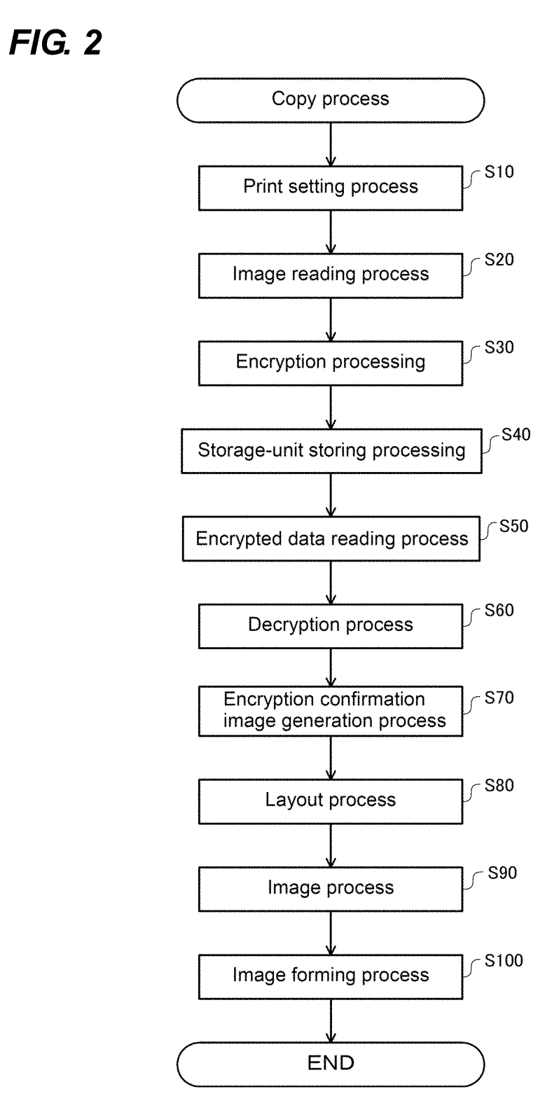

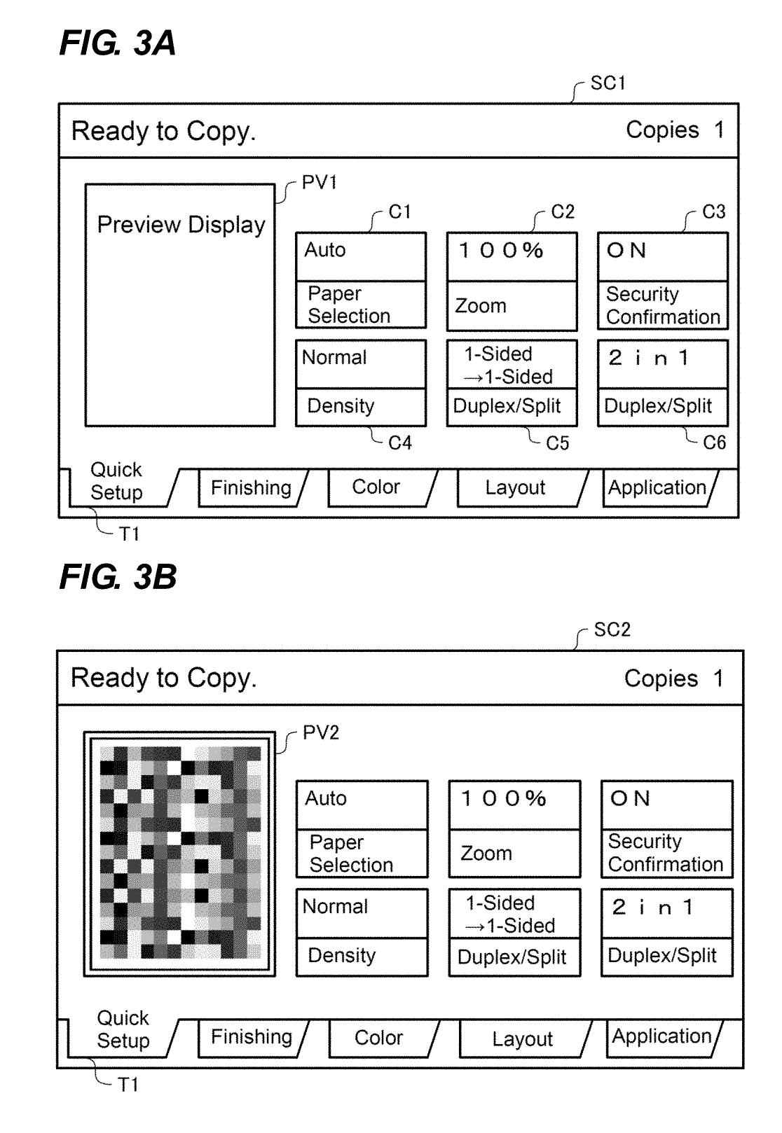

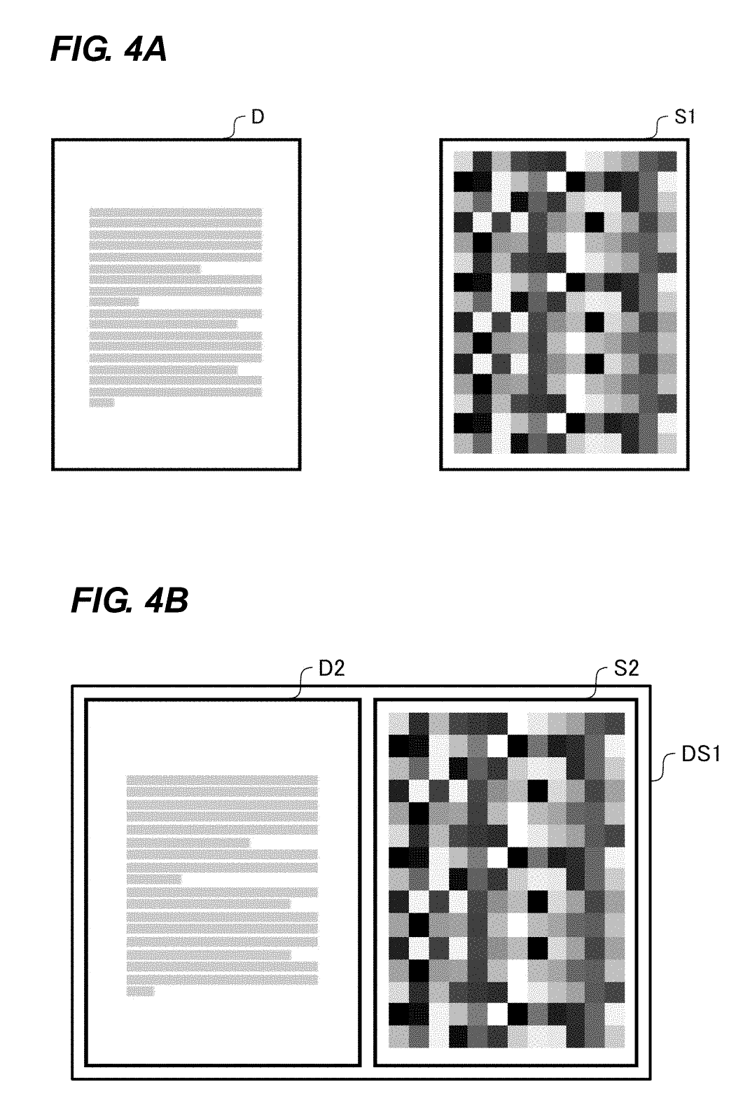

FIG. 2 illustrates contents of a copy process according to the one embodiment. FIGS. 3A and 3B illustrate explanatory diagrams illustrating examples of displaying an encryption confirmation image on a user interface screen according to the one embodiment. FIGS. 4A and 4B illustrate explanatory diagrams illustrating examples of a copy layout using the encryption confirmation image according to the one embodiment. The disclosure is not limited to copying and is applicable to a reception of print job and a transmission of fax.

At Step S10, the user executes a print setting process. In the print setting process, the control unit 110 accepts a user input regarding a print setting using the operation display 170. As illustrated in FIG. 3A, the operation display 170 displays a user interface screen SC1. The user interface screen SC1 includes a quick setup tab T1, a finishing tab, a color tab, a layout tab, and an application tab. In this example, the quick setup tab T1 is selected.

The quick setup tab T1 includes: a window PV1 for displaying a preview screen; an icon C1 for setting a paper sheet selection; an icon C2 for setting a zoom; an icon C3 for security confirmation setting; an icon C4 for setting a density; an icon C5 for setting 1-sided printing or 2-sided printing; and an icon C6 for page aggregation, such as 2 in 1 and 4 in 1.

In this example, the icon C3 for security confirmation setting indicates the setting where an encryption confirmation image S1 is displayed in a window PV2 for displaying a preview screen (ON display). Furthermore, since in the icon C6 for page aggregation, 2 in 1 of page aggregation is set, and the icon C3 for security confirmation setting indicates “ON,” the setting where a raw image D2 and an encryption confirmation image S2 are reduced and displayed in two-page spread is ensured (see FIG. 4B).

The control unit 110 may be configured to display the encryption confirmation image S1 in the window PV2 for displaying a preview screen, which is displayed in relation to a printed matter to be output, to only a limited user, such as a login user and a user who has received authentication. When the storage unit 140 has a user storage region (not illustrated and also referred to as a BOX), the control unit 110 may be configured to perform the display to only a user who is allowed to use the user storage region and a user who has a special authority.

At Step S20, the image reading unit 150 reads a raw image D on an original document (not illustrated) to generate the image data ID as scan data (see FIG. 4A). As described above, the image data ID is digital data that is not compressed and has tone values of RGB for each pixel.

At Step S30, the encryption processing unit 161 executes encryption processing on the image data ID. In the encryption processing, for example, Advanced Encryption Standard (AES) can be used as an encryption standard. AES has three types: “AES-128,” “AES-192,” and “AES-256” in accordance with their key lengths. “AES-128” has the shortest key length and a processing time is short, and meanwhile, “AES-128” is in a “weak” mode where its encryption strength is comparatively weak. “AES-192” has a medium key length, a processing time is also medium, and its encryption strength is medium. “AES-256” has the longest key length, a processing time is long, and meanwhile, “AES-256” is in a “strong” mode where its encryption strength is comparatively strong.

At Step S40, the control unit 110 stores encrypted image data ED as the image data encrypted by the encryption processing unit 161 in the storage unit 140 (see FIG. 1). The reason why it is stored in the storage unit 140 is to eliminate the need for performing image reading again by the user when a paper jam occurs during the copy process of the image forming apparatus 100. In other words, this is because when the paper jam is solved, the image data ID of the scanned raw image D can be reproduced even when the image forming apparatus 100 is reset.

At Step S50, the control unit 110 reads the encrypted image data ED from the storage unit 140 to transmit it to the decryption processing unit 162. At Step S60, the decryption processing unit 162 executes a decrypting process. In the decrypting process, the decryption processing unit 162 decrypts the encrypted image data ED to restore the image data ID. When a paper jam and similar trouble do not occur, the control unit 110 omits the decrypting process and can directly use the image data ID that is not compressed stored in a volatile storage region (not illustrated), such as a RAM. In this description, both the image data ID generated by the decrypting process and the image data ID before encryption are referred to as non-compressed image data.

At Step S70, the decryption processing unit 162 executes an encryption confirmation image generation process. In the encryption confirmation image generation process, the decryption processing unit 162 generates encryption confirmation image data SD, which is regarded as decrypted, without decrypting the encrypted image data ED. The encryption confirmation image data SD is handled as data indicating the encryption confirmation image in the image forming apparatus 100 (see FIG. 4A).

Specifically, for example, assume that the image data ID has attribution data indicating that it is RGB image data that is not compressed, and meanwhile, the encrypted image data ED has attribution data indicating that it is image data on which encryption has been performed. In this case, the decryption processing unit 162 rewrites only the attribution data into the attribution data indicating that it is RGB image data that is not compressed without decrypting the encrypted image data ED. Thus, when the encrypted image data ED is recognized as an image, a random color image is reproduced.

When the encrypted image data ED and the image data ID do not have the attribution data, the decryption processing unit 162 simply skips the decrypting process to transmit the encrypted image data ED as the image data ID to the image processing unit 120 without rewriting the attribution data. Thus, in the embodiment, the encrypted image data ED is regarded as the image data ID and handled, which generates the encryption confirmation image data SD.

At Step S80, the layout processing unit 121 executes a layout process. In the layout process, the layout processing unit 121 sets a layout to print using the encrypted image data ED and the image data ID. In this example, as described above, the layout processing unit 121 sets the layout such that the raw image D2 reduced in two-page spread and the encryption confirmation image S2 are displayed (see FIG. 4B). That is, in this example, the layout processing unit 121 arranges the raw image D2 and the encryption confirmation image S2 in a one to one arrangement at an identical size to generate a print image DS1. Thus, printing the raw image D2 and the encryption confirmation image S2 on one paper causes the print image DS1 to be used as a certificate where the encryption has been performed in an internal process through the image formation.

Furthermore, since the icon C3 for security confirmation setting indicates “ON,” the layout processing unit 121 displays the encryption confirmation image S1 in the window PV2 for displaying a preview screen in a user interface screen SC2. The layout processing unit 121 can execute only a display of the encryption confirmation image S1 in the user interface screen SC2 in accordance with a user setting (omit printing of the encryption confirmation image S2), or the layout processing unit 121 can omit the display of the encryption confirmation image S1 in the window PV2 for displaying a preview screen.

At Step S90, the color conversion processing unit 122 performs the color conversion on the image data as the RGB data, on which the layout process has been executed, into the CMYK data. The halftone processing unit 123 executes the halftone process on the CMYK data to generate the print data as the halftone data of CMYK. This causes the encryption confirmation image data SD to reproduce the encryption confirmation image S2, which is a random color image, in a predetermined region of the print image DS1, and meanwhile, the image data ID consequently reproduces the raw image D2.

At Step S100, the image forming unit 130 forms the print image DS1 based on the print data on the print medium to output it as a printed matter. Thus, the image forming unit 130 can form the print image DS1, where the encryption confirmation image S2 and the raw image D2, which are reduced and arranged in a predetermined layout, are combined on the print medium.

This enables the user to print the encryption confirmation image S2 together with the raw image D2 when the temporary storage in a non-volatile storage device is performed during the internal process of the image forming apparatus 100. As described above, the encryption confirmation image S2 is an image where contents of encrypted actual data are imaged. This enables the image forming apparatus 100 to visually show contents of actual encryption processing to the user when the temporary storage in the non-volatile storage device is performed during the internal process of the image forming apparatus 100.

Thus, with the one embodiment, the image forming apparatus 100 can show the contents of actual encryption processing to the user when the temporary storage in the non-volatile storage device is performed during the internal process of the image forming apparatus 100. This enables the image forming apparatus 100 to directly and visually show a fact that a countermeasure for preventing unauthorized use of the image data ID temporarily stored in the non-volatile storage device is performed during the internal process of the image forming apparatus 100 to the user. When especially, the image forming apparatus 100 is shared in, for example, a convenience store, the disclosure has an advantage that widely shows its high security to an ordinary user.

In addition to the above-described respective embodiments, the following modifications implement the disclosure.

### First Modification

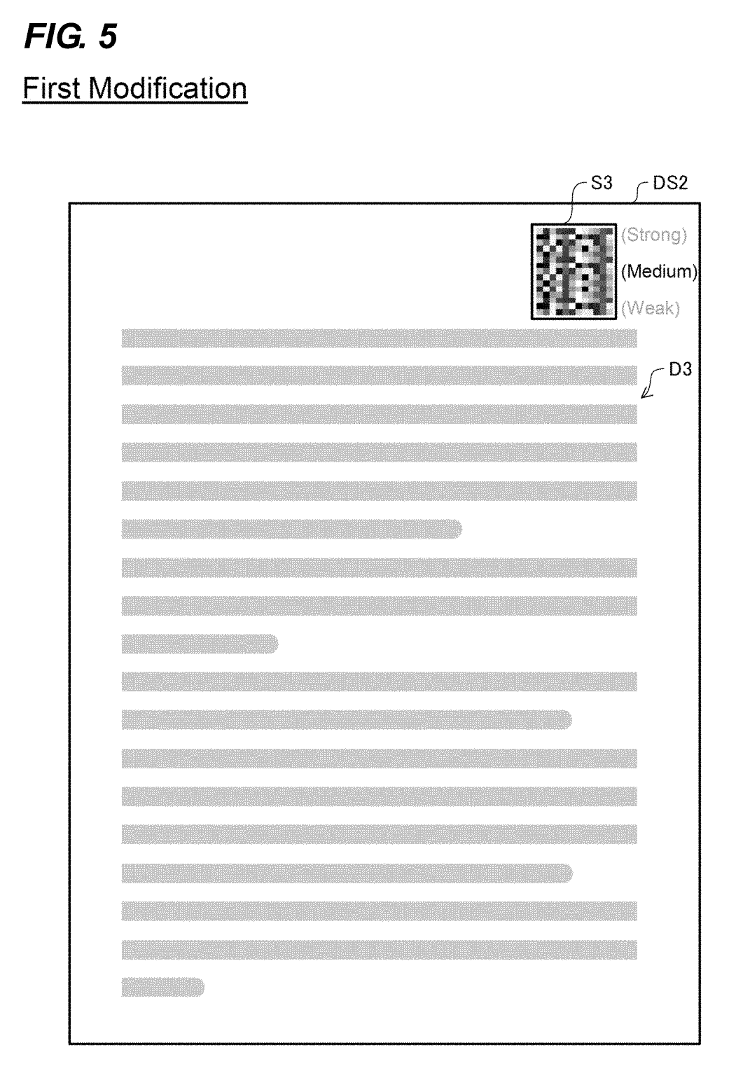

While in the above-described embodiment the encryption confirmation image and the raw image are arranged side by side at an identical size, it is not limited to such arrangement. Specifically, for example, as illustrated in FIG. 5, in a print image DS2, a raw image D3 is displayed large, and an encryption confirmation image S3 is located as a thumbnail in a header. This enables the print image DS2 to display the raw image D without an excessive reduction.

Furthermore, on the right side of the encryption confirmation image S3, any one word of “strong,” “medium,” and “weak” is displayed at dark density in accordance with an encryption strength, and the other words are displayed at light density. This example shows that “medium” is displayed at dark density, and “AES-192” is selected.

### Second Modification

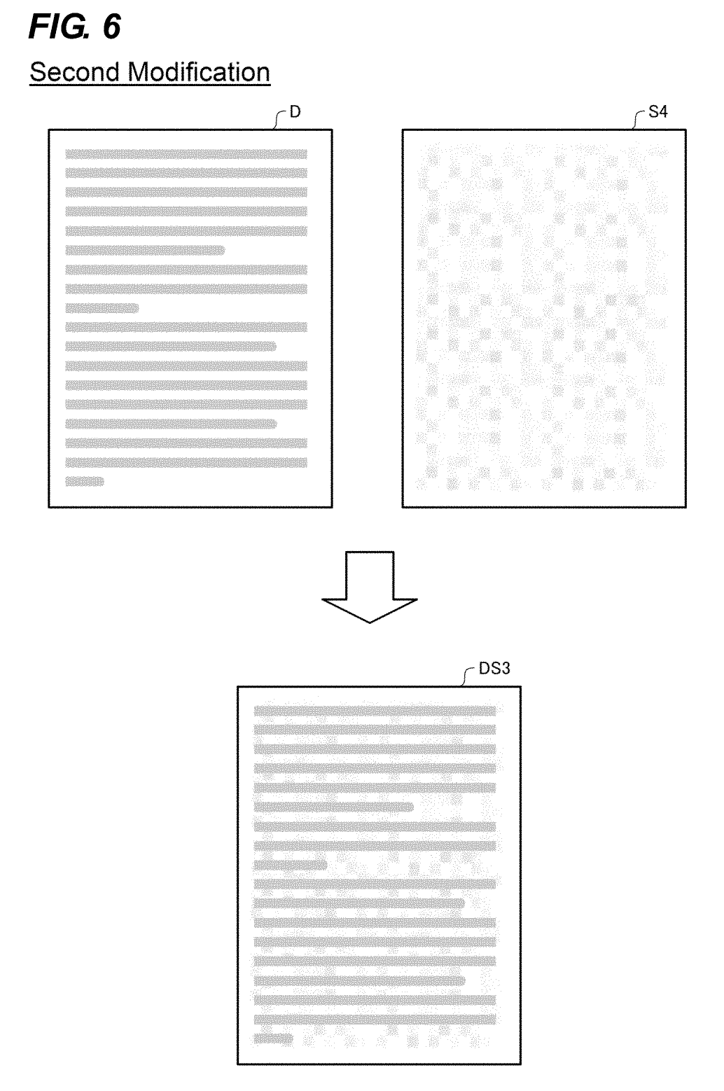

While in the above-described embodiment the encryption confirmation image and the raw image are located at positions at which they do not mutually interfere, it is not limited to such arrangement. Specifically, for example, as illustrated in FIG. 6, an encryption confirmation image S4 is generated as a state where the density of the encryption confirmation image S1 is reduced, and the encryption confirmation image S4 is arranged superimposed on the raw image D as a background of the raw image D, which generates a print image DS3.

### Third Modification

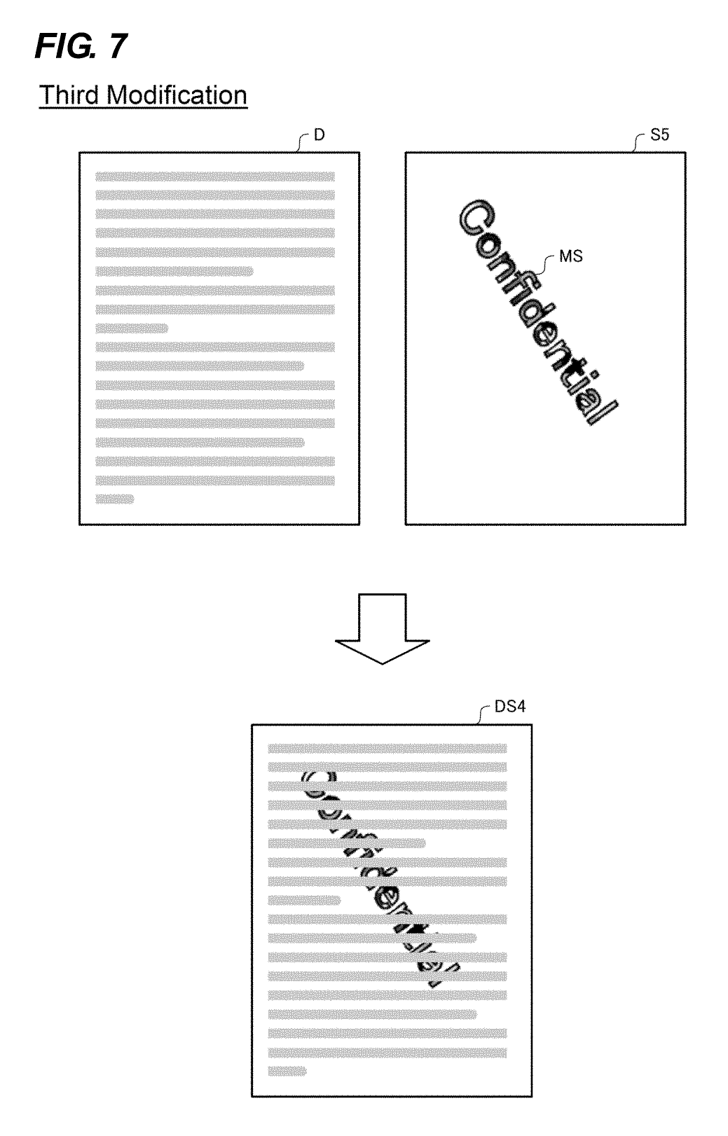

While in the above-described embodiment the encryption confirmation image is displayed without changing its shape, the shape can be changed and displayed. Specifically, for example, as illustrated in FIG. 7, a word (in this example, “Confidential”) representing predetermined confidentiality is extracted from the encryption confirmation image S1 to generate an encryption confirmation image S5 including an encryption confirmation symbol MS that is a symbol made from the encryption confirmation image S1. The encryption confirmation image S5 can be arranged superimposed on the raw image as the background of the raw image, which generates a print image DS4.

The symbol includes characters, a character string, such as “Internal Use Only” and “Copyright,” is available, and is available as also a Bates stamp. The user may be allowed to freely set the content of the character string and may be allowed to freely set it including ON/OFF and its size in a detail setting screen activated by touching the icon C3 for security confirmation setting.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image forming apparatus that forms a print image on a print medium, the image forming apparatus comprising:
an encryption processing unit that encrypts non-compressed image data, the non-compressed image data being not compressed and indicating a raw image as a target of the forming to generate encrypted image data;
a storage unit storing the generated encrypted image data;
a decryption processing unit that decrypts the stored encrypted image data to restore the non-compressed image data; and
an image output unit that forms the print image on the print medium using the non-compressed image data to output a printed matter; wherein
the image forming apparatus regards and processes the encrypted image data as the non-compressed image data to generate encryption confirmation image data indicating an encryption confirmation image, so as to associate and then display the encryption confirmation image with the printed matter using the encryption confirmation image data.

2. The image forming apparatus according to claim 1, further comprising an operation display that accepts an operation input from a user, wherein the operation display displays the encryption confirmation image as a preview during a setting of the printed matter.

3. The image forming apparatus according to claim 1, further comprising a layout processing unit that arranges the encryption confirmation image and the raw image in a predetermined layout, wherein the image output unit forms the encryption confirmation image and the raw image on the print medium, the encryption confirmation image and the raw image being arranged in the predetermined layout.

4. The image forming apparatus according to claim 3, wherein the layout processing unit arranges the encryption confirmation image and the raw image side by side at an identical size.

5. The image forming apparatus according to claim 3, wherein the layout processing unit reduces a density of the encryption confirmation image, and superimposes and arranges the encryption confirmation image having the reduced density on the raw image.

6. The image forming apparatus according to claim 3, wherein the layout processing unit generates a symbol representing a predetermined meaning using the encryption confirmation image, and superimposes and arranges the symbol on the raw image in a state where a density of the generated symbol is reduced.

7. An image forming method that forms a print image on a print medium, the image forming method comprising:
encrypting non-compressed image data, the non-compressed image data being not compressed and indicating a raw image as a target of the forming to generate encrypted image data;
storing the generated encrypted image data;
decrypting the stored encrypted image data to restore the non-compressed image data; and
forming the print image on the print medium using the non-compressed image data to output a printed matter; wherein
the image forming method regards and processes the encrypted image data as the non-compressed image data to generate encryption confirmation image data indicating an encryption confirmation image, so as to associate and then display the encryption confirmation image with the printed matter using the encryption confirmation image data.

8. A non-transitory computer-readable recording medium storing an image forming program for controlling an image forming apparatus that forms a print image on a print medium, the image forming program causing the image forming apparatus to function as:
an encryption processing unit that encrypts non-compressed image data, the non-compressed image data being not compressed and indicating a raw image as a target of the forming to generate encrypted image data;
a storage unit storing the generated encrypted image data;
a decryption processing unit that decrypts the stored encrypted image data to restore the non-compressed image data; and
an image output unit that forms the print image on the print medium using the non-compressed image data to output a printed matter; wherein
the image forming apparatus regards and processes the encrypted image data as the non-compressed image data to generate encryption confirmation image data indicating an encryption confirmation image, so as to associate and then display the encryption confirmation image with the printed matter using the encryption confirmation image data.
